(19) United States
(12) Patent Application Publication
(10) Pub. No.: US 2018/0368620 A1
(43) Pub. Date: Dec. 27, 2018

(54) Cooking Pan

(71) Applicants: Ofer Shmerling, Kfar Chaim (IL); Iftah Shaked, Mazkeret Batia (IL)

(72) Inventor: Ofer Shmerling, Kfar Chaim (IL)

(21) Appl. No.: 15/628,914

(22) Filed: Jun. 21, 2017

(51) Int. Cl. A47J 37/10

(52) U.S. Cl. CPC A47J 37/10; A47J 43/00

(57) ABSTRACT

A cooking pan for sautéing food is provided the cooking pan includes a bottom portion having a central axis of the pan passing therethrough; a sidewall extending upwardly from and surrounding the bottom portion, the sidewall includes a handle section for coupling thereto a gripping handle; and a stirring facilitating section extending upwardly from the sidewall opposite the holding section; the stirring facilitating section includes a top portion covering a portion of the bottom portion such that when a force is exerted on the content of the pan the content slides along the stirring facilitating section and causes stirring of the content.

### FIELD OF INVENTION

The presently disclosed subject matter relates to cooking pan, in general, and in particular to a cooking pan for stir-frying and sautéing.

### BACKGROUND

Cooking pans, particularly, frying or sautéing pans, are widely available in a variety of configurations and arrangements, including designs having a sidewall whose distal portion, i.e. the portion that is disposed opposed the pan's grip handle, has a curved profile enabling sautéing by the application to the cooking pan of a generally horizontal, distally directed force without the need of this force having a vertical component.

U.S. Pat. No. 6,497,174B1, CN947366 and U.S. Pat. No. 1,398,655 disclose examples of cooking pans, of the above kind, in each of which the curved sidewall distal has a higher height relative to the cooking pan's bottom, than the remainder of the sidewall. In use, when the cooking pan is sharply moved horizontally, towards and away from the user, food pieces therein are propelled upwards along the distal side wall portion and are directed by its curved profile to land back inside the cooking surface of the cooking pan. When frying a flat food piece, this cooking pan configuration enables the food piece to be turned upside down by simply being pushed towards the distal sidewall portion with a single movement of a spatula or by single pushing the whole cooking pan through its handle.

Further examples of cooking pans of the kind, to which the presently disclosed subject matter refers, are disclosed in CN201398836, CN104545421 and US2014319152.

In particular, CN201398836 discloses a high-low pan comprising a pan body and a pan handle. The high-low pan is characterized in that the pan body is an inclined opening pan body; when the pan body is placed horizontally, one side of the pan body, which is connected with the pan handle, is the lowest side, and one side of the pan body, which is farthest from the pan handle is the highest side. The side of the pan body, which is connected with the pan handle is the back side of the pan body, and the side of the pan body, which is farthest from the pan handle, is the front side of the pan body. The pan body has a structure that the front side is higher than the back side, therefore, when the food is turned over or the pan body is tilted, the food is not easy to fall out from the front side of the pan body.

CN104545421 discloses a crescent cooking pan, which belongs to the technical field of kitchen utensils and comprises a pan body. The pan body comprises a pan bottom and a pan wall, wherein the pan wall encircles the arc of the pan bottom and extends upward. When the opening extends and vertical to the horizontal datum, one side surface of the pan wall stops extending, the other side surface which corresponds to the side surface drives the adjacent left and right side surface to go on extending upward and to extend to the inner side arc, the pan wall is enabled to be lower at one side and higher at the other corresponding side, the adjacent left and right sides of the pan incline from the higher position to the lower position to form a crescent structure, and the three side surface of the opening of the pan wall are curled inward.

US2014319152A discloses multi-purpose cooking vessel comprising a body having a concave shape; and a handle attached to the body. The body includes: a flat bottom plate; and a sidewall formed on the circumference of the bottom plate. The sidewall includes: a lower sidewall which is formed from the circumference of the bottom plate and is extended upwardly and rounded externally; and an upper sidewall which is extended upwardly from the top of the lower sidewall and bent rounded internally toward inside of the body. The top edge is inclined such that the height of the upper sidewall gradually increases from a first side of the body toward a second side of the body located opposite to the first side. An opening portion of the top of the sidewall is formed to have a circle shape.

### SUMMARY OF INVENTION

There is provided in accordance with an aspect of the presently disclosed subject matter a cooking pan for sautéing food, the pan including a bottom portion having a central axis of the pan passing therethrough; a sidewall extending upwardly from and surrounding the bottom portion, the sidewall includes a handle section for coupling thereto a gripping handle; and a stirring facilitating section extending upwardly from the sidewall opposite the holding section; the stirring facilitating section includes a top portion covering a portion of the bottom portion such that when a force is exerted on the content of the pan the content slides along the stirring facilitating section and causes stirring of the content.

The central axis can extend between a front half of the pan and a back half thereof wherein the handle section is located in the back half and the stirring facilitating section is located in the front half, wherein the stirring facilitating section extends along a section D1 of the circumference of the sidewall wherein the section D1 extends along the front section of the pan.

The section D1 can extend along between 0.25-0.5 of the circumference of the sidewall.

The section D1 can extend along about ⅓ of the circumference of the sidewall.

The top portion can be configured with an angle with respect to the bottom portion such that the top portion is directed upwardly with respect to the bottom portion. The angel can be configured such that the content in the pan is urged slightly upwardly and is urged to fly towards the handle section. The angel can further be configured to allow release of steam from the pan such that the steam is directed upwardly away from the stirring facilitating section.

The top portion together with the section of the sidewall, from which the top portion extends can form a continuous inner surface configured to allow content of the pan to slide thereon. The inner surface can be configured with a circular path, such that the content of the pan is urged to follow a circular trajectory path, directing the content towards the area of the pan in proximity of the handle section.

The cooking pan can further include two lateral extensions extending from the sidewalls towards the top portion of stirring facilitating section. The lateral extensions can be configured to preclude the content of the pan from slipping out of the pan while force is exerted thereon towards the stirring facilitating section. Each of the lateral extensions can extend in diagonal from a lip of the sidewall and merge with the top portion. A section D2 can extend along the circumference of the sidewall between the two lateral extensions wherein the section D2 is about half of the circumference of the sidewall.

The cooking pan can further include an elevated wall section configured to preclude contents of the pan from flying out of the circumference of the sidewall.

The top portion can extend to a height with respect to the bottom portion which is between 1.5 to 3 the height of the sidewalls. The top portion can cover a section of the bottom portion such that between 20%-40% of the central axis is covered by the top portion.

### BRIEF DESCRIPTION OF THE DRAWINGS

In order to understand the disclosure and to see how it may be carried out in practice, embodiments will now be described, by way of non-limiting examples only, with reference to the accompanying drawings, in which:

FIG. 1 is a side view of the a cooking pan in accordance with an example of the presently disclosed subject matter;

FIG. 2 is a top view of the cooking pan of FIG. 1;

FIG. 3 is a back side perspective view of the cooking pan of FIG. 1; and

FIG. 4 is a front side perspective view of the cooking pan of FIG. 1.

### DETAILED DESCRIPTION OF EMBODIMENTS

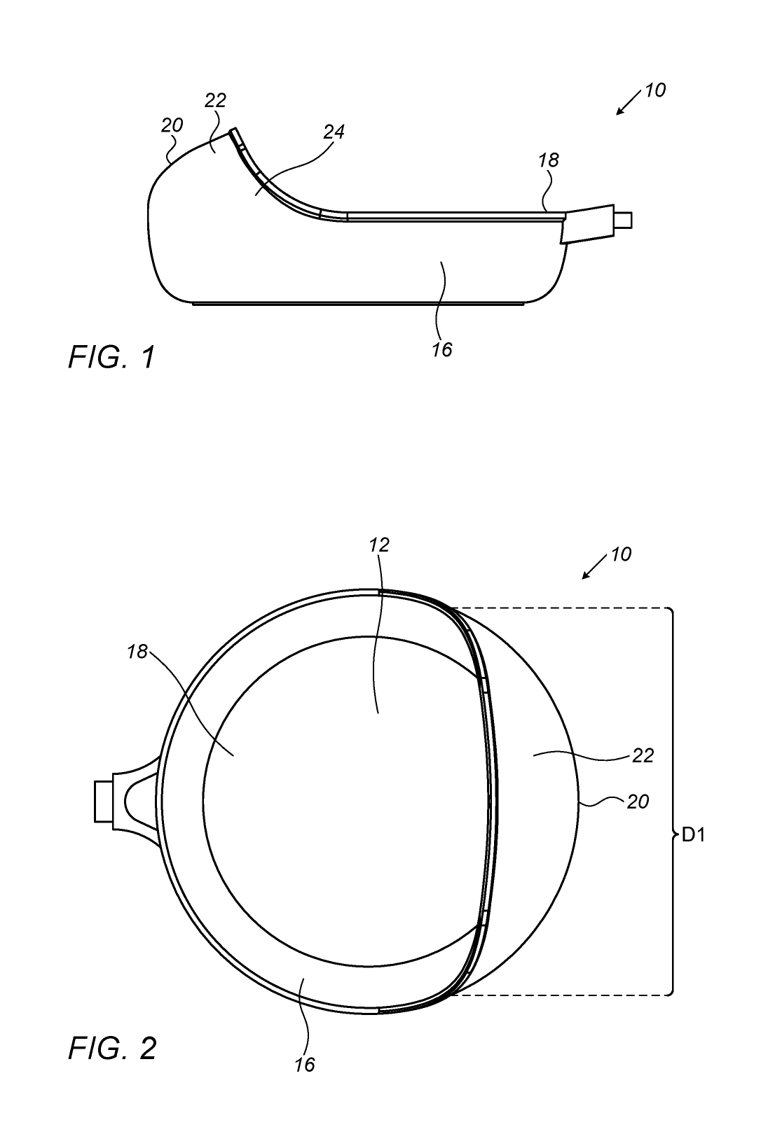

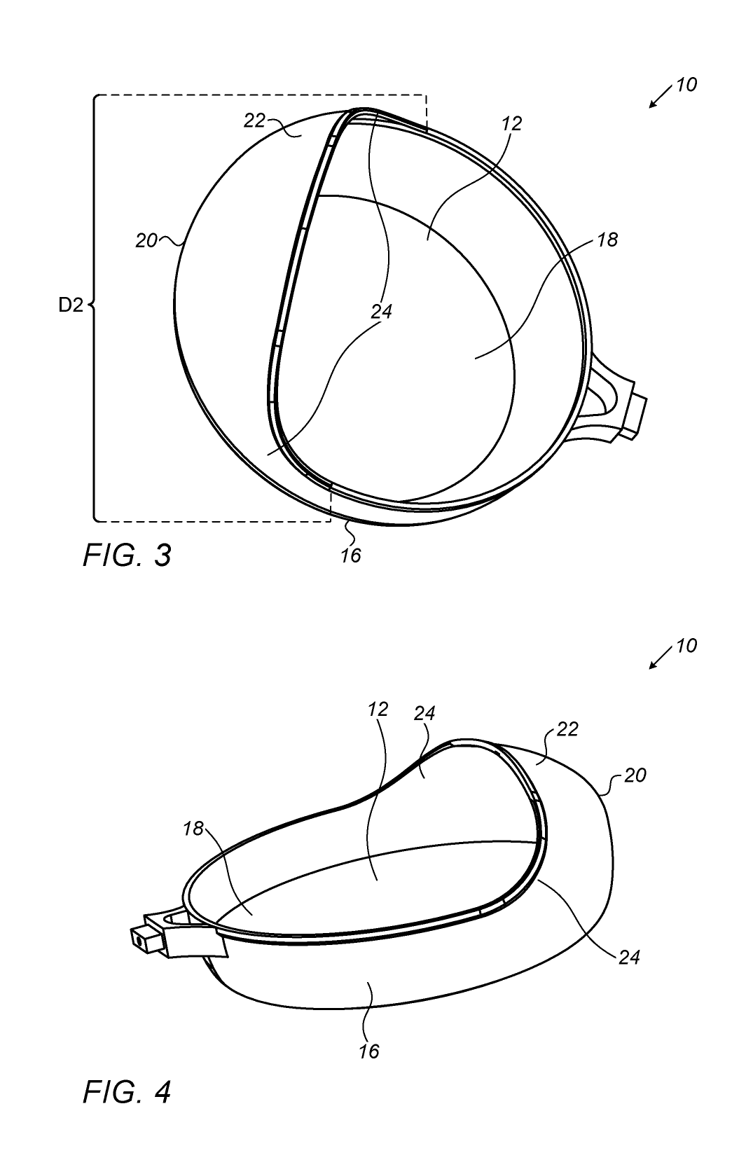

FIG. 1 shows a cooking pan 10 including a bottom portion 12 having a central axis 14 of the pan 10 passing therethrough. The cooking pan 10 further includes a sidewall 16 extending upwardly from and surrounding the bottom portion 12. The sidewall 16 includes a handle section 18 for coupling thereto a gripping handle (not shown).

The bottom portion 12 can be circular, oval, rectangular or of any other shape. The cocking pan 10 further includes a stirring facilitating section 20 extending upwardly from the sidewall 16 opposite the holding section 18. The stirring facilitating section 20 includes a top portion 22 covering a portion of the bottom portion 12 such that when a force is exerted on the content of the pan 10 the content slides along the stirring facilitating section 20 and causes the stirring of the content.

The stirring facilitating section 20 according to an example can extend along a section D1 of the circumference of the sidewall 16. D1 can extend along the entire half front of the pan, i.e. to cover the front half of the pan 10, opposite the handle section 18. According to an example the pan is a circular pan having a circular bottom portion, and the section D1 of the circumference of the sidewall 16 from which stirring facilitating section 20 extends is between 0.25-0.5 of the circumference of the sidewall 18. According to an example, the section D1 is about ⅓ of the circumference of the sidewall 18.

The top portion of the stirring facilitating section 20 is configured with an angle with respect to the bottom portion 12. i.e. the top portion is not disposed in parallel to the bottom portion 12, rather it extends slightly at an upward angel. The top portion 22 together with the section of the sidewall 16, from which it extends, and the corresponding section of the bottom portion 12 form a continuous inner surface 25 configured to allow the content of the pan 10 to slide thereon.

As a result when force is applied on the content of the pan 10, the food pieces are urged along the inner surface 25 towards the top portion 22. Due to the angle of the top portion the food pieces are urged slightly upwardly such that under the force exerted thereon, these food pieces fly towards the back of the pan, i.e. the section of the pan which is in proximity with the handle section 18. This way, the food pieces are mixed and the contents of the pan 10 is stirred facilitating thereby stir-frying and sautéing of the food in the pan.

According to an example the inner surface 25 is configured with a circular path, such that the food pieces are urged to follow a circular trajectory path, directing the food pieces towards the back area of the pan 10, i.e. the area in proximity of the handle section 18. The stirring facilitating section 20 thus facilitates stirring of the food pieces without having to use a stirring utensils.

According to an example the angle of the top portion 22 is further configured to allow release of steam from the pan 10, i.e. the angle is configured such that steam from the area of the bottom portion 12 which is underneath the top portion 22, is directed away from the stirring facilitating section 20. This way, the steam is not accumulated on the inner surface of the top portion 22 and condensation of the steam on the inner surface of the top portion 22 is precluded. It is appreciated that it is desirable to remove condensation of steam on the inner portion is undesirable as the humidity inside the pan 10.

According to an example, the pan 10 further includes two lateral extensions 24 extending from the sidewalls 16 towards the top portion 22 of stirring facilitating section 20. The lateral extension can be configured to preclude the content of the pan from slipping out of the pan while force is exerted thereon towards the stirring facilitating section 20. The lateral extensions 24 can extends in diagonal from lip of the sidewall 16 at about a midpoint of the circumference thereof between the stirring facilitating section 20 and the holding section 18. The two lateral extensions 24 can extend from the two sides of the stirring facilitating section 20 and can merge therewith, such that the section D2 of the circumference extending between the two lateral extensions 24 can be about half of the circumference of the sidewall 16.

In addition, according to an example the top portion 22 extends to a height with respect to the bottom portion 12 which is between 1.5-3 times the height of the sidewalls 16. In addition, the top portion can be configured to cover a section of the bottom portion such that between 20-40% of a central axis of the bottom portion is covered by the top portion. According to an example, the top portion 22 extends to a height with respect to the bottom portion 12 which is about twice the height of the sidewalls 16 and the top portion covers about ¼ of the central axis of the bottom portion. This way, the pan is mostly open however allowing enough space for stirring the contents thereof with the stirring facilitating section 20.

According to a further example, the back of the pan 10, i.e. the area in proximity to the handle section 18, can further include an elevated wall section (not shown), for example The elevated wall section can be configured to preclude food pieces from flying out of the pan 10. I.e. food pieces which are urged by the stirring facilitating section 20 to the front of the pan 10 towards the handle section 18 may accidently fly further away from the pan, the elevated wall section is configured to stop these food pieces and direct them back into the pan 10.

In operation, the user wishing to use the pan for stir-frying and sautéing of the food pieces such as vegetables, places the ingredients in the pan 10 together with the desired amount of oil or other fats. When stirring is required, the user holds the handle of the pan and applies, with the hand holding the griping handle, a forward force in a direction towards the stirring facilitating section 20. As a result, the food pieces inside the pan 10 are urged forwards towards the stirring facilitating section 20. The food pieces sliding on the inner surface 25 formed by the top portion 22 of the stirring facilitating section 20 together with the corresponding section of the sidewall 16. It is appreciated that the force applied on the pan 10 is such which causes the food pieces to slide along the inner surface 25 and to further fly after reaching the edge of the top portion 22. The force is such which causes the food pieces to land back on the bottom portion 12 of the pan 10 at areas closer to the handle section 18. Due to the force applied on the pan 10 and consequently on the food pieces therein, the areas of the pan 10 closer to the handle section 18 are empty of food pieces. Thus, following the stirring motion of the food pieces, the food pieces which were on top tend to be the first to be urged towards the stirring facilitating section 20. As a result these pieces are first to reach the areas of the pan 10 closer to the handle section 18. The stirring facilitating section 20 thus causes food pieces disposed on top of other food pieces to reach the bottom portion 12 of the pan 10.

Those skilled in the art to which the presently disclosed subject matter pertains will readily appreciate that numerous changes, variations, and modifications can be made without departing from the scope of the invention, mutatis mutandis.

1. A cooking pan for sautéing food, the pan comprising:
a bottom portion having a central axis of the pan passing therethrough;
a sidewall extending upwardly from and surrounding the bottom portion, said sidewall includes a handle section for coupling thereto a gripping handle;
a stirring facilitating section extending upwardly from said sidewall opposite the holding section; said stirring facilitating section includes a top portion covering a portion of said bottom portion such that when a force is exerted on the content of the pan the content slides along said stirring facilitating section and causes stirring of the content.

2. The cooking pan of claim 1 wherein said central axis extends between a front half of the pan and a back half thereof wherein said handle section is located in said back half and said stirring facilitating section is located in said front half, wherein said stirring facilitating section extends along a section D1 of the circumference of the sidewall wherein said section D1 extends along said front section of the pan.

3. The cooking pan of claim 2 wherein the section D1 extends along between 0.25-0.5 of the circumference of the sidewall.

4. The cooking pan of claim 2 wherein the section D1 extends along about ⅓ of the circumference of the sidewall.

5. The cooking pan of claim 1 wherein said top portion is configured with an angle with respect to said bottom portion such that the top portion is directed upwardly with respect to the bottom portion.

6. The cooking pan of claim 5 wherein said angel is configured such that the content in the pan is urged slightly upwardly and is urged to fly towards the handle section.

7. The cooking pan of claim 6 wherein said angel is further configured to allow release of steam from the pan such that the steam is directed upwardly away from the stirring facilitating section.

8. The cooking pan of claim 1 wherein said top portion together with the section of the sidewall, from which said top portion extends form a continuous inner surface configured to allow content of the pan to slide thereon.

9. The cooking pan of claim 8 wherein said inner surface is configured with a circular path, such that the content of the pan is urged to follow a circular trajectory path, directing the content towards the area of the pan in proximity of the handle section.

10. The cooking pan of claim 1 further comprising two lateral extensions extending from the sidewalls towards the top portion of stirring facilitating section.

11. The cooking pan of claim 10 wherein said lateral extensions are configured to preclude the content of the pan from slipping out of the pan while force is exerted thereon towards the stirring facilitating section.

12. The cooking pan of claim 11 wherein each of said lateral extensions extends in diagonal from a lip of the sidewall and merge with said top portion.

13. The cooking pan of claim 10 wherein a section D2 extends along the circumference of the sidewall between the two lateral extensions wherein said section D2 is about half of the circumference of the sidewall.

14. The cooking pan of claim 1 further comprising an elevated wall section configured to preclude contents of the pan from flying out of the circumference of the sidewall.

15. The cooking pan of claim 1 wherein said top portion extends to a height with respect to said bottom portion which is between 1.5 to 3 the height of the sidewalls.

16. The cooking pan of claim 15 wherein said top portion covers a section of said bottom portion such that between 20%-40% of the central axis is covered by said top portion.
